(19) United States
(12) Patent Application Publication
(10) Pub. No.: US 2026/0307299 A1
(43) Pub. Date: Oct. 8, 2026

(54) MICRO-OPTICS FABRICATION USING TOMOGRAPHIC ADDITIVE MANUFACTURING

(71) Applicant: National Research Council of Canada, Ottawa (CA)

(72) Inventors: Daniel WEBBER, Kanata (CA); Antony ORTH, Ottawa (CA); Yujie ZHANG, Ottawa (CA); Michel PICARD, Ottawa (CA); Chantal PAQUET, Ottawa (CA); Jonathan BOISVERT, Ottawa (CA)

(21) Appl. No.: 19/481,457

(22) PCT Filed: May 2, 2024
(86) PCT No.: PCT/IB2024/054251

§ 371 Date: Nov. 4, 2025

(30) Foreign Application Priority Data
May 5, 2023 (CA) 3200686
Dec. 18, 2023 (CA) 3223693

(51) Int. Cl. B29C 35/08; B29C 37/00

(52) U.S. Cl. CPC B29C 35/08; B29C 2037/903

(57) ABSTRACT

A method and apparatus are set forth for volumetric additive manufacturing (VAM) wherein light rays that are used to determine tomographic projections are modelled using ray tracing, in order to account for projector non-telecentricity and etendue in all three dimensions. The path of rays from each light source (e.g. pixel) are computed as they propagate through the VAM system. Optical effects such as refraction, transmission loss, absorption, etendue, and non-telecentricity are intrinsically accounted for via ray tracing. Using these rays, the required dose to solidify the photosensitive resin is computed.

### BACKGROUND OF THE INVENTION

### 1. Field of the Invention

The present invention is directed to light-based additive manufacturing, and more particularly to methods of volumetric additive manufacturing wherein light rays that are used to determine tomographic projections are modelled using ray tracing.

### 2. Description of the Related Art

Most 3D printing techniques involve adding material layer by layer. This sets some limitations on the types of applications for which 3D printing is suitable, such as printing around a preexisting object. In light-based volumetric additive manufacturing (VAM), such as tomographic additive manufacturing (TAM), photocurable resin is exposed to spatially structured (i.e. 3D) light that causes the resin to cure. The 3D light dose applied to the resin dictates the shape of the object that is printed, which permits printing entire complex objects through one complete revolution, thereby circumventing the need for layering. However, the fidelity of the printed object relies on precise delivery of light to each volume (i.e. voxel) within the vial. The dose of light required to print an object is traditionally computed using tomographic means, such as the Filtered Back Projection (FBP) algorithm for image reconstruction whereby a series of projections of the target object as viewed at different angles is computed by filtering the data along the direction of projection, and performing a back projection operation where the data is painted back in the image along the projection direction.

The intensity of each pixel in the projection image represents the line integral along the same angle of the projection viewpoint. Through the central slice theorem, the target object can be reconstructed given enough projections spanning a sufficient range of viewing angles. As a requisite of the central slice theorem, the line integrals must be computed over parallel paths. Consequently, 3D tomographic VAM printers are constructed to have chief rays parallel to the optical axis (i.e. telecentric) and have a minimal spread of light, referred to as etendue.

Tomographic VAM printers are known that use a UV laser source with telecentric focusing optics wherein the printing vial is immersed in an index matching solution to simultaneously achieve low etendue and parallel rays in the print volume and thereby reduce refraction-induced effects.

Telecentricity and low-etendue can also be achieved in VAM printers by using specialized projection optics on the output of a DLP projector, such as a 4F imaging arrangement with a centrally-located aperture stop to limit off-axis light rays and make the system image-space telecentric.

It is also known to compensate for finite etendue by modeling the beam divergence as Gaussian. Although this approach is valid for the case of parallel rays passing through a build volume that originate from a Gaussian optical source (e.g. a laser), the approach is not generally valid for all optical configurations since optical effects (e.g. refraction, aberrations) can distort the distribution of light within the print volume.

VAM systems are also known for correcting projector non-telecentricity and refraction at the air-vial interface wherein the angle and position of light rays propagating through the vial are determined and used to resample the tomographic projections calculated by the Radon transform. Although such systems account for refraction and telecentricity within the vial plane, non-telecentric error along the vial axis is not accounted for, resulting in a reduction in print fidelity along the vial axis, which can manifest as fine features not being printed. Such systems are also limited in terms of achievable vertical size of the build volume and minimum tomographic printer system length. This is a consequence of geometry; to maintain a small chief-ray angle with respect to the optical axis, the projector focus distance must be made much larger than the projected image size.

The speed of tomographic printing is partly determined by the amount of light that can be delivered to the absorbing print volume. In an LED-driven projector-based tomographic printer, the large etendue of the LED source requires a small system aperture to achieve a small etendue, making the system optically inefficient. The amount of light can be increased either by increasing the LED current, or by increasing the size of the system aperture. Increasing the LED current is normally employed since it maintains the tomographic printing requirements, however light output is typically linear with input current such that the range is limited. Furthermore, due to optical inefficiency, much of the input power is wasted as thermal loss. Increasing the system aperture has the advantage that the light output scales as the square of the aperture diameter, however the etendue requirement is compromised since the projector depth of field is shortened, limiting the build volume and resolution of the printer system.

According to recent publication: Toombs, Science, Volumetric additive manufacturing of silica glass with microscale computed axial lithography, Science, 376 (2022) https://www.science.org/doi/10.1126/science.abm6459, VAM has been demonstrated to be capable of making micro-optics in silica with smooth surfaces created due to post-print sintering in high-temperature furnace. However, this method requires extensive post-processing and adds complexity. Further, according to another recent publication: Rackson, Latent image volumetric additive manufacturing, Opt. Lett. 47, 5(2022 ), https://opg.optica.org/ol/abstract.cfm?uri=ol-47-5-1279, VAM has again been demonstrated to be capable of making micro-optics in silica with Smooth surfaces created due to post-print sintering in high-temperature furnace. However, the Rackson method requires precise knowledge of part gelation properties (timing) and additional procedural step (flood exposure).

According to WO2024/069276 there is provided a method of tomographic printing that accounts for projector non-telecentricity and etendue in all three dimensions.

What is desired, however, is to reduce Horizontal lines defects in parts relative to WO2024/069276 and provide for smooth surfaces, without the avoiding the complexity, post-processing, advanced requirements and additional procedure compared to the Toombs and/or Rackson methods.

### SUMMARY OF THE INVENTION

It is an aspect of this specification to set forth a method that improves upon previous methods by the use of large etendue (Large spread of light in print volume creates blurring effect that smooths surfaces) via the use of ray-tracing (calculating ray paths in 3D transiting the printing system).

### BRIEF DESCRIPTION OF THE DRAWINGS

FIG. 1 shows a VAM system for printing a 3D object, according to the prior art.

FIG. 2 is a block diagram of an apparatus for volumetric additive manufacturing, according to an embodiment.

FIG. 3 is a flowchart showing steps of a method of volumetric additive manufacturing, according to an embodiment.

FIGS. 4(a) and 4(b) are elevation views showing corrected light ray paths for printing an object within a vial of photocurable resin using a method of computing tomographic projections in VAM using ray-tracing, according to an embodiment (FIG. 4(a)) and according to the prior art Radon-based approach (FIG. 4(b)), while FIGS. 4(c) and 4(d) are plan views corresponding to FIGS. 4(a) and 4(b).

FIGS. 5(a) to (d) show a light ray passing through a voxelized version of a three-dimensional representation of an object to be manufactured for calculation of tomographic projections and target dose.

FIG. 6 shows a comparison between test objects manufactured according to the prior art and using the apparatus of FIG. 2 and the method of FIG. 3, where FIG. 6(a) shows a test object located at a printing position within a vial, FIG. 6(b) is a left-side view of the object in FIG. 6(a), FIG. 6(c) is an image of the left-side of a manufactured object without correction for 3D non-telecentric projection, FIG. 6(d) is an image of the left-side of the manufactured object with correction for 3D non-telecentric projection using the method of FIG. 3, where FIG. 6(e) is a front-side view of the object in FIG. 6(a), where FIG. 6(f) is an image of a front-side of the manufactured object without correction for 3D non-telecentric projection and FIG. 6(g) is an image of a front-side of the manufactured object with correction for 3D non-telecentric projection using the method of FIG. 3.

FIG. 7 shows a comparison between further test objects manufactured according to the prior art and using the apparatus of FIG. 2 and the method of FIG. 3, where FIGS. 7(a) and (b) are perspective and plan views of the further test object to be manufactured, FIG. 7 (c) is a microscope image of the object printed using prior art Radon-based 2D non-telecentric correction, FIG. 7(d) is similar to FIG. 7(c) but with a larger projection aperture, FIG. 7(e) is similar to FIG. 7(d) but with correction using the method of FIG. 3, FIGS. 7(f)-(h) are video snapshots of an optical scattering tomography (OST) signal during printing of the further test object in FIGS. 7(c)-(e) respectively, and FIGS. 7(i)-(k) are optical profilometry images of the further test objects in FIGS. 7(c)-(e) respectively.

### DETAILED DESCRIPTION OF THE PREFERRED EMBODIMENTS

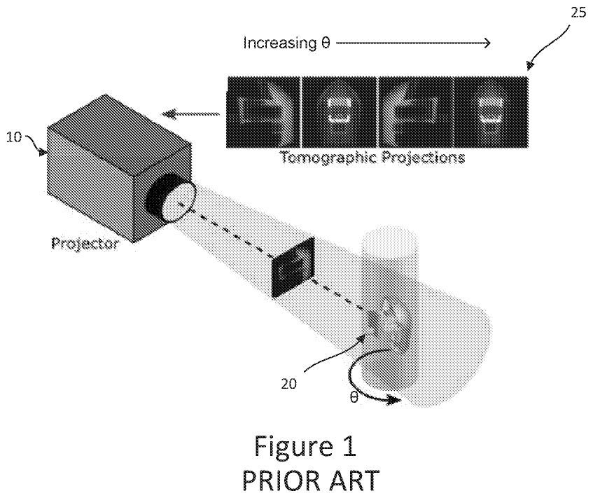

FIG. 1 shows a typical VAM system for printing a 3D object. A Digital Light Processing (DLP) projector 10 is used to project patterns of structured (i.e. 3D) light images onto a cylindrical vial 20 of photocurable resin that is mounted to a rotation stage. In DLP projectors, an image is created by uniformly illuminating a digital micromirror device (DMD) with light rays from a UV LED source. The DMD comprises an array of microscopically small mirrors laid out in a matrix on a semiconductor chip.

Each mirror represents one or more pixels in the projected image, and the number of mirrors corresponds to the resolution of the projected image. In VAM, the mirrors are repositioned rapidly to reflect light onto the vial 20. The tomographic projections 25 from projector 10 are updated as the vial 20 rotates for at least one entire revolution (typically multiple rotations lasting ~60 seconds) such that the shape of the light dose distribution matches the desired object shape, as shown by the succession of tomographic projections 25 corresponding rotation angle θ of the rotating vial 20. Unlike some prior art VAM printing systems, there is no requirement for an index-matching bath vial 20, which improves the versatility of the system since an immersing bath must have the same index of refraction as that of the photocurable resin which requires time consuming and sensitive tuning of the bath.

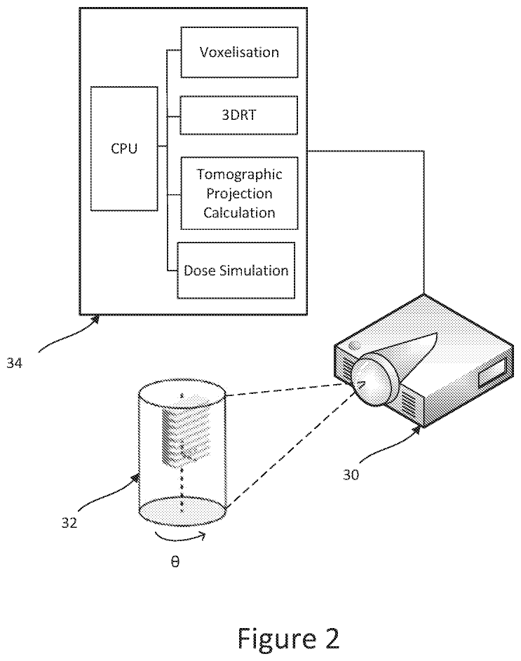

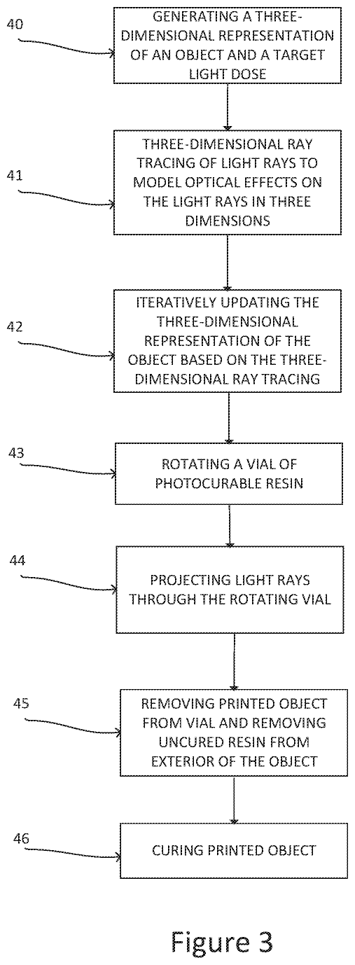

According to an embodiment, modeling of the optical rays is used as an a priori feedback mechanism to improve print fidelity in a non-idealized tomographic printer, as shown in FIG. 2. The printer comprises a DLP projector 30 for transmitting light rays onto a rotating vial 32 of photocurable resin that is mounted to a rotation stage. A computing device 34 contains computer memory for performing the steps depicted in FIG. 3.

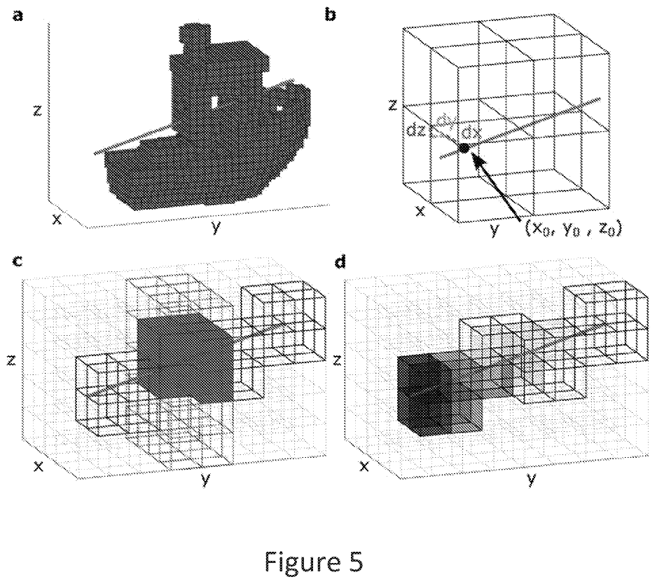

At step 40, the computing device 34 generates a three-dimensional representation of an object to be manufactured within the rotating vial 32, as well as a target light dose for manufacturing the object (i.e. printing the object in the photocurable resin). In an embodiment, an STL file representing the surface geometry of a three-dimensional object is converted into a logical 3D voxel array via a voxelisation process, where 1 or 0 represent the presence or absence of a part of the object. Next, the data is converted into a single-precision floating-point data type of an initial target dose. A voxelized version of the three-dimensional representation of an object (toy boat)is shown in FIG. 5, discussed below.

At step 41, the computing device 34 models optical effects on the light rays in three dimensions as they pass through the rotating vial 32, using three-dimensional ray tracing (3DRT) of light rays from the DLP projector 30. Such optical effects include refraction, transmission loss, absorption, etendue, and non-telecentricity.

At step 42, the computing device 34 performs tomographic projection calculations and dose simulation for iteratively updating the three-dimensional representation and the target light dose based on the three-dimensional ray tracing (3DRT), to account for the optical effects. This culminates in an optimized set of tomographic projections.

At step 43, the rotating stage rotates the vial 32 and at step 44 DLP projector 30 transmits the optimized tomographic projections from step 42 through the rotating vial to manufacture the object.

At step 45, the printed object is removed from the vial 32, uncured resin exterior to the object is removed, and at step 46 the printed object is cured to solidify any uncured photocurable resin.

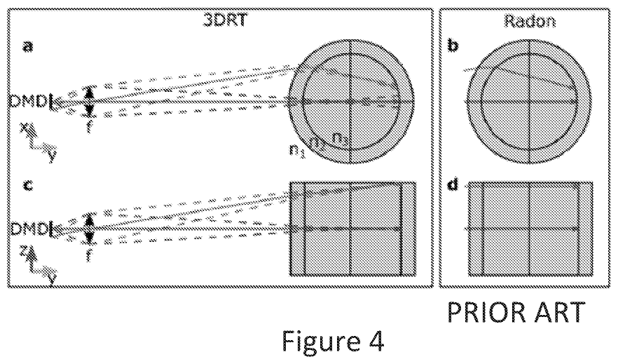

FIGS. 4(a) and (c) show light ray paths for a volumetric printer according to the method and apparatus of FIGS. 2 and 3, from projector 30 in air (n1) focused onto cylindrical vial 32 (index n2) containing photocurable resin (index n3), where optical effects such as refraction, transmission loss, absorption, etendue, and non-telecentricity are accounted for via ray tracing. The chief and marginal rays are plotted as solid and dashed lines respectively. Due to the cylindrical geometry of the vial 32, strong refraction occurs in the XY plane resulting in chief rays being focused towards the optical axis. Furthermore, due to rotational asymmetry of the cylindrical vial 32, the system is astigmatic resulting in different foci for the sagittal and tangential planes. This is visually depicted as different points of focus in the XY and YZ planes of FIGS. 4(a) and (c), respectively.

Using these rays, the required dose to solidify the photosensitive resin is computed, as discussed below. Also, the combined effect of refraction and finite etendue results in a curved focal plane within the print volume.

In contrast, rays computed using the Radon approach shown in FIGS. 4(b) and 4(d), have two important differences. First, only chief rays are considered which is valid only when a low-etendue source is used. Second, due to the dimensionality of the Radon approach, rays are approximated as telecentric in the ZY plane (shown as flat rays in FIG. 4(d), placing a limitation on the correction for larger chief-ray angles with respect to the optical axis.

In an embodiment, the three-dimensional ray tracing (3DRT) at step 41 of FIG. 3 can be performed by computing device 34 computing ray propagation and refraction at each material interface between the DLP projector and vial 32 using a vectorized form of Snell's law where, for each pixel in the DMD voxel array, N rays are propagated to the first optical element in the system (e.g. the air/vial interface). The direction of each ray is stored as a Cartesian unit vector, and the direction of the chief ray is determined by the location of the aperture stop of the projector 30. The direction of the non-chief rays is determined by the size of the aperture stop. Hexagonal filling may be used to define non-chief ray locations on the aperture stop. Computing device 34 then computes the direction of each non-chief ray based on these locations.

At the intersection of the light-ray and each optical element surface, the direction of the refracted ray is computed and the ray is propagated to the next surface in the optical system (e.g. the vial/resin interface). This process is repeated until the rays have intersected the final surface of the system (e.g. the inner-diameter of the vial 32 that is furthest from the projector 30). The ray coordinates within the vial 32 are used to compute a set of Cartesian indices of intersection between the DMD voxel array and each ray passing through the print volume contained within vial 32. These indices of intersection are used in computing both the tomographic projections as well as the light dose delivered discussed above with reference to step 42.

Calculation of the tomographic projections and dose at step 42 of FIG. 3 can be performed using the same methodology as the Radon-based approach discussed above but for line-integrals in three-dimensions and for multiple rays per pixel.

According to an embodiment, to avoid aliasing artefacts due to a light ray passing through a discrete voxel array, an anti-aliasing approach can be used where the ray can interact with neighbouring voxels, as depicted in FIG. 5. FIG. 5(a) shows a light ray passing through a three-dimensional array of voxels representing an object (toy boat) to be manufactured, where each voxel represents a target light dose. FIG. 5(b) is a magnified view of the light ray passing through eight of the voxels representing a rear wall of a cabin portion of the toy boat, where the position (x₀, y₀, z₀) is the position of the ray originating from a pixel on the DMD of projector 30, and where the distance of that ray to the nearest integer voxel can be represented within a given voxel by the distances dx, dy, dz. Each pixel in the DMD transmits a light ray which can traverse the voxel array in 3D. As the light ray propagates through the voxel array containing the target dose (depicted by the blue-outlined voxels in FIG. 5(c)), it intersects all black-outlined voxels extending along the entire path of the ray in the voxel array. In FIG. 5, blue outlined voxels correspond to voxels of the target dose while solid blue voxels correspond to the intersection between the voxels that the ray interacts with and the target dose. The intensity of the pixel from which this ray originated is given by the sum of all voxels that the ray intersects with the target dose, shown as the solid blue voxels. This is repeated for N rays from each pixel, for each pixel in the DMD pixel array, and subsequently for 360 angular samples of the target dose.

The rays used to calculate the tomographic projections are also used to simulate the delivered dose, also discussed above with reference to step 42. Tomographic projections covering 360 degrees in 1 degree increments are transmitted through the simulated print volume. For each tomographic image, a ray from each pixel is cast through the print volume along a pre-determined ray path. For each voxel that the ray intersects, a dose is added to the voxel that is the product of the tomographic pixel intensity (determined from the tomographic projection calculation discussed above), a scaling weight due to the anti-aliasing method discussed above, transmission loss at the air/vial interface, and transmission loss due to optical absorption through the print volume. FIG. 5 (d) shows the corresponding dose calculation for the tomographic projection calculation shown in FIG. 5 (c). The magnitude of the delivered light dose is shown by the voxel shading, where darker corresponds to more dose. Due to optical absorption, voxels nearest the optical source (projector 30) receive more dose. Optical transmission at the print-volume interface is calculated using the Fresnel coefficients for unpolarized light, and attenuation within the volume is computed using Beer-Lambert absorption. In the case of simulating a system with finite etendue, the above steps are repeated for the number of rays cast from each pixel, and then again for all tomographic projections culminating in the final dose delivered to the print volume.

According to an embodiment, in order to increase the calculation speed when executing step 42, the smallest voxel size (side length given by the projector pixel size) can be down-sampled by 4×4×4 pixels.

Prior to the final curing step 46, the printed object placed in a dish filled with isopropyl alchohol (IPA) to soak for 15 minutes after being removed from the vial 32 and then. Then, the object is placed in a vacuum chamber and pumped for 5 minutes. Finally, while under vacuum, the object can be exposed to a 405 nm light (#irradiance mW/cm\hat{ }2) for 5 minutes in order to cure any uncured resin.

The vial 32 can be an open top vial that is kept at room temperature in a dark storage container until all air bubbles in the resin have been eliminated (by visual inspection) and to allow the resin to reach room temperature.

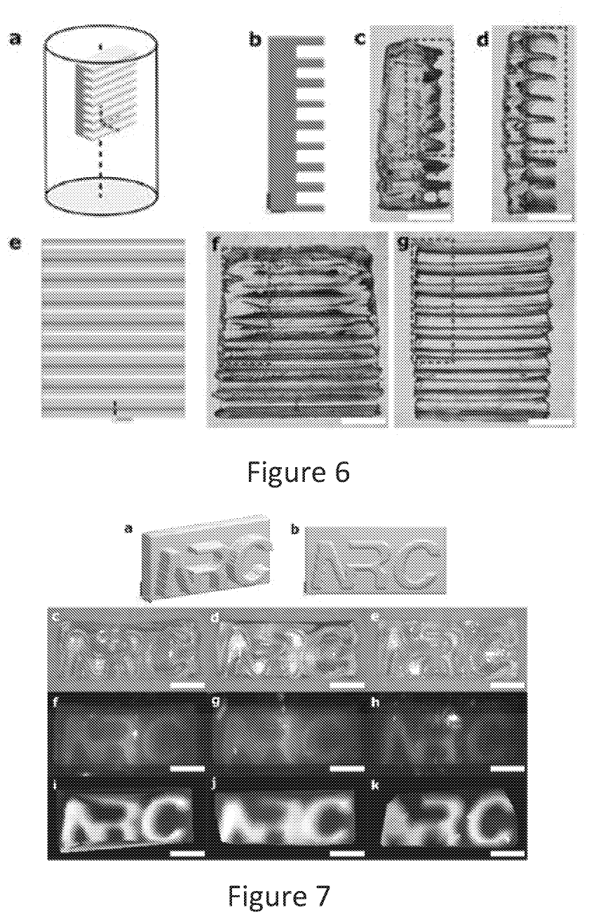

FIG. 6 shows test results for an object manufactured according to the apparatus of FIG. 2 and method of FIG. 3, where projector 30 is non-telecentric and the target object to be manufactured has a geometry comprising of a series of parallel fins oriented normal to the axis of the vial 32. The object was printed on the axis of the vial with the base (co-located with the origin in FIG. 6(a)) positioned on the optical axis of the projector 30.

The test object was printed with 3D non-telecentric correction and using 2D non-telecentric correction for comparison purposes. Optical images of the resulting parts are shown in FIGS. 6(c), 6(d) and 6(f), 6(g) respectively, for front and side views. For both parts, print termination was determined when all fins formed in the part as viewed using optical scattering tomography (OST) imaging modality. For the parts printed using 2D non-telecentric correction (dashed regions in FIG. 6(c), 6(f) a reduction in part quality can be seen with increasing distance from the projector optical axis, resulting in only three of nine fins printing correctly. The top view of the object printed using 2D non-telecentric correction (FIG. 6(f)) most clearly shows this reduction in print quality, as the parallel fins are only resolvable for the portion of the object printed along the vial axis. Regions of the object printed away from the vial axis show a thickening of the fins to the point that they are unresolvable, as can be seen from the side view (FIG. 6(c)).

During printing, the fins nearest the optical axis are formed first. As a result, once the upper-most fins are formed the bottom fins become overexposed resulting in a general thickening of the object, as shown by the tapering of the object in FIG. 6(c). This is a direct consequence of non-telecentricity, as the intensity of light (and dose delivered) decreases for an increasing chief-ray angle with respect to the optical axis.

In contrast, the object printed with 3D non-telecentric correction as set forth above with reference to FIGS. 2-5 , shows good conformity to the test geometry, with all none fins correctly printed, as observed in the dashed regions of FIG. 6(d), 6(g). Further, it can be seen that the solid rectangular base of the fins has a uniform thickness indicating that correction has compensated for the reduction in applied dose due to chief-ray divergence. A slight bending in the upper-most fins is observed which may be corrected with further optimization of the tomographic projections.

The increase in vertical build volume using 3D non-telecentric correction as compared to 2D non-telecentric correction can be quantified by the number of fins correctly printed using both methods. Whereas only three of nine fins correctly formed with Radon-based 2D non-telecentric correction, with 3DRT-based 3D non-telecentric correction all fins corrected formed, indicating at least a three-fold increase in print volume with a vertical build size of 38 mm (where the vertical build size (38 mm) is limited only by the height of the refracted projector image within the print volume).

The impact of astigmatism and other etendue-related effects on tomographic print quality can be seen in FIG. 6, wherein a further test object shown in FIGS. 7(a,b)) was printed with projector 30 using aperture diameters of 2.5 mm and 16 mm corresponding to a full axial beam divergence of 1.9 and 12.2 degrees respectively. FIG. 7(c) is a microscope image of the object printed using Radon-based 2D non-telecentric correction with a 2.5 mm aperture. The letters “NRC” in the print are clearly resolvable, and can be more clearly seen in the OST image shown in FIG. 7(f).

Conversely, the part printed using Radon-based 2D non-telecentric correction with 16 mm aperture (FIG. 7(d),(g)) has decreased print fidelity, as evident by the thickening of letters as well as the partial forming of the letter “R”. This point is most evident in optical profilometry measurements (FIG. 6(j)) where the height between the letters “R” and “C” is mostly uniform, whereas parts of the letter “R” are much lower in height coinciding with the partially-formed appearance in the microscope images.

FIG. 7(e), (h), (k) are a microscope image, OST snapshot, and optical profilometry measurement, respectively, of the object printed using 3DRT-based 3D non-telecentric correction with a 16 mm aperture. All letters are clearly formed with good conformity to the model. In particular, the letter “R” is fully formed, the letters “R” and “C” are clearly separated, and the height of all letters is uniform.

In an aspect of the present invention, projections 25 may be preferentially blurred by employing an optical projection system that has large etendue. This blurring smoothens printed part surfaces (a blurred tomography) suitable for the fabrication of optical components. According to the art, pencil-beam thin beams make up the projections that are normally employed. These are compatible with prior art systems such as WO2024/069276. However, with the use of ray tracing it becomes possible to employ a projections with large etendue for use in tomographic additive manufacturing Optical blurring of the projections may be achieved, for example, by use of a large etendue source, by moving the focal plane outside the print volume, and/or by the insertion of optical elements. The use of large etendue may generate blur in the optical path, allowing for a tradeoff between resolution on one hand and smoothness and/or uniformity on the other.

As set forth above, a new apparatus and method of computing projections in tomographic VAM is provided. By modeling optical rays in three-dimensions, the tomographic projection and delivered dose can be accurately determined, resulting in improved print fidelity over Radon-based 2D non-telecentric correction in both telecentric and non-telecentric printing systems, without the need for an index-matching immersive bath.

Applications of the apparatus and method set forth herein may include unconventional printing configurations such as tomosynthetic geometry and systems utilizing multiple photoinitiators with different activation wavelengths, such as stiffness control.

It should be noted that although only refractive geometries are discussed herein, it is contemplated that the same principles can be applied to reflection geometries.

The apparatus and method set forth herein permits the use of a broad range of printer configurations. For example, projection systems with a smaller throw ratio (and correspondingly shorter overall system length) can be used.

The resulting improved printing fidelity for complex structures also leads to possible applications such as printing of mechanical metamaterials useful for microgravity and space-based manufacturing, micro optics, fabrication, microfluidics fabrication and biomedical device fabrication.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### REFERENCES

[1] B. E. Kelly, I. Bhattacharya, H. Heidari, M. Shusteff, C. M. Spadaccini, and H. K. Taylor, “Volumetric additive manufacturing via tomographic reconstruction,” Science 363, 1075-1079 (2019).
[2] D. Loterie, P. Delrot, and C. Moser, “High-resolution tomographic volumetric additive manufacturing,” Nat. Commun. 11, 852(2020 ).
[3] C. M. Rackson, K. M. Champley, J. T. Toombs, E. J. Fong, V. Bansal, H. K. Taylor, M. Shusteff, R. R. McLeod, “Object-space optimization of tomographic reconstructions for additive manufacturing,” Additive Manufacturing 48, 102367 (2021).
[4] I. Bhattacharya, J. Toombs, and H. K. Taylor, “High fidelity volumetric additive manufacturing”, Additive Manufacturing 47, 102299 (2021).
[5] A. Orth, K. L. Sampson, K. Ting, K. Ting, J. Boisvert, and C. Paquet, “Correcting ray distortion in tomographic additive manufacturing,” Opt. Express 29, 11037-11054 (2021)
[6] B. D. Moran. E. J. Fong, C. C. Cook, M. Shusteff, “Volumetric additive manufacturing system optics,” Proc. SPIE 11698 (2021)
[7] J. Madrid-Wolff, A. Boniface, D. Loterie, P. Delrot, C. Moser, “Light-based volumetric additive manufacturing in scattering resins,” arXiv 2105, 14952 (2021)

What is claimed is:

1. A method of blurred tomography volumetric additive manufacturing, comprising:
generating a three-dimensional representation of an object to be manufactured within a rotating vial and a target light dose for manufacturing the object;
three-dimensional ray tracing of light rays from a pixel array through the rotating vial thereby modelling optical effects on the light rays in three dimensions as they pass through the rotating vial;
iteratively updating the three-dimensional representation and the target light dose based on the three-dimensional ray tracing to account for the optical effects;
rotating the vial of photocurable resin;
projecting blurred light rays from the pixel array conforming to the updated three-dimensional representation at the updated target light dose onto the rotating vial to manufacture the object;
removing the manufactured object from the vial and uncured resin from exterior of the object; and
curing the manufactured object to solidify any uncured photocurable resin.

2. The method of claim 1, wherein the three-dimensional ray tracing of light rays comprises computing ray propagation and refraction at each material interface between the pixel array and the object to be manufactured, and generating a set of Cartesian indices of intersection for each voxel between the pixel array and each material interface.

3. The method of claim 2, wherein iteratively updating the three-dimensional representation comprises using the computed ray propagation to compute the updated target light dose and comparing the updated target light dose to a previous iteration of target light dose until there are no differences therebetween.

4. The method of claim 1, wherein the optical effects include at least one of refraction, transmission loss, absorption, etendue, and non-telecentricity.

5. The method of claim 1, wherein an initial three-dimensional representation of the object to be manufactured comprises an STL file representing the three-dimensional surface geometry that is converted into a voxel array in three dimensions for illuminating the pixel array.

6. The method of claim 2, wherein computing ray propagation and refraction at each material interface comprises Radon-based non-telecentric correction using line-integrals in three-dimensions for multiple rays per voxel.

7. The method of claim 6, wherein for a voxel representing the target light dose the intensity of a pixel from which a given light ray originates is calculated by summing all voxels with which the given light ray intersects.

8. The method of claim 7, wherein the intensity is calculated for N rays from each pixel in the pixel array, and for 360 angular samples of the target light dose, thereby eliminating aliasing artefacts due to a light ray passing through a discrete voxel array.

9. The method of claim 8, wherein iteratively updating the target light dose comprises:
i) transmitting tomographic projections from the pixel array through a print volume within the vial, covering 360 degrees in one-degree increments;
ii) for each tomographic projection, casting a ray from each pixel of the pixel array through the print volume along a pre-determined ray path;
iii) for each voxel that the casted ray intersects, adding a dose weight to the voxel that is the product of tomographic pixel intensity, a scaling weight due to eliminating aliasing artefacts, transmission loss at the interface, and transmission loss due to optical absorption through the print volume;
iv) calculating optical transmission at the interface using Fresnel coefficients for unpolarized light;
v) calculating attenuation within the print volume using Beer-Lambert absorption;
vi) repeating iii)-v) for all rays cast from each voxel; and
vii) repeating ii)-vi) for all tomographic projections culminating in a final target light dose.

10. The method of claim 1, further comprising soaking the printed object in isopropyl alchohol (IPA) after removing the printed object from the vial and before curing the printed object.

11. The method of claim 1, wherein curing the printed object is under vacuum.

12. The method of claim 1, wherein the printed object is cured using 405 nm light (#irradiance mW/cm\hat{ }2).

13. Apparatus for blurred tomography volumetric additive manufacturing, comprising:
a rotating vial containing a photocurable resin;
a computing device for
generating a three-dimensional representation of an object to be manufactured within the rotating vial and a target light dose for manufacturing the object;
three-dimensional ray tracing of light rays through the rotating vial thereby modelling optical effects on the light rays in three dimensions as they pass through the rotating vial; and
iteratively updating the three-dimensional representation of the object to be manufactured and the target light dose based on the three-dimensional ray tracing to account for the optical effects; and
a DLP projector having a DMD pixel array for transmitting large etendue light rays conforming to the updated the three-dimensional representation at the updated target light dose onto the rotating vial for manufacturing the object.

14. The apparatus of claim 13, wherein the three-dimensional ray tracing of light rays comprises computing ray propagation and refraction at each material interface between the DMD pixel array and the object to be manufactured, and generating a set of Cartesian indices of intersection for each voxel between the DMD pixel array and each material interface.

15. The apparatus of claim 14, wherein iteratively updating the three-dimensional representation of the object comprises using the computed ray propagation to compute the updated target light dose and comparing the updated target light dose to a previous iteration of target light dose until there are no differences therebetween.

16. The apparatus of claim 13, wherein the optical effects include at least one of refraction, transmission loss, absorption, etendue, and non-telecentricity.

17. The apparatus of claim 14, wherein an initial three-dimensional representation of the object to be manufactured comprises an STL file representing the three-dimensional surface geometry that is converted into a voxel array in three dimensions for illuminating the DMD pixel array.

18. The apparatus of claim 17, wherein the set of Cartesian indices is generated using a vectorized form of Snell's law where, for each pixel in the voxel array, N light rays are propagated to a first optical element, the direction of each light ray being stored as a Cartesian unit vector, and the direction of a chief light ray being determined by the aperture stop of the DLP projector, wherein the direction of non-chief light rays is determined by the size of the aperture stop, wherein hexagonal filling is used to define non-chief light ray locations on the aperture stop, and wherein the computing device computes the direction of each non-chief ray based on the locations.

19. The method of claim 1 wherein said blurring of the projections is achieved by at least one of: a large etendue source, optical elements, and a displaced focal plane.

20. The apparatus of claim 13 wherein said blurring of the projections is achieved by at least one of: a large etendue source, optical elements, and a displaced focal plane.
